(19) United States
(12) Patent Application Publication
(10) Pub. No.: US 2012/0297862 A1
(43) Pub. Date: Nov. 29, 2012

(54) METHOD OF CHECKING A MEMBRANE FILTRATION MODULE OF A FILTRATION PLANT

(75) Inventors: Stephan Mayr, Regensburg (DE); Jörg Zacharias, Koefering (DE)

(73) Assignee: KRONES AG, Neutraubling (DE)

(21) Appl. No.: 13/433,335

(22) Filed: Mar. 29, 2012

(30) Foreign Application Priority Data
Mar. 31, 2011 (DE) 10 2011 006 545.8

(51) Int. Cl. G01N 15/08; F16L 21/035

(52) U.S. Cl. 73/38; 285/351

(57) ABSTRACT

A method of checking a membrane filtration module of a filtration plant, where the membrane filtration module includes a discharge pipe for the filtrate and a membrane element for filtering a liquid, and includes filling the membrane filtration module with a liquid, so that the membrane element is completely immersed in the liquid, and introducing compressed air into the discharge pipe.

### CROSS-REFERENCE TO RELATED APPLICATION

The present application claims the benefit of priority of German Application No. 102011006545.8, filed Mar. 31, 2011. The entire text of the priority application is incorporated herein by reference in its entirety.

### FIELD OF THE DISCLOSURE

The present disclosure relates to a method of checking a membrane filtration module of a filtration plant, wherein the membrane filtration module comprises a discharge pipe for the filtrate, and also to an adapter for the connection with a discharge pipe of a membrane filtration module of a filtration plant.

### BACKGROUND

Membrane filtration modules are employed, for example, in water treatment. These are usually ultrafiltration plants. Here, plastic membranes whose pore sizes are within a range of about 1 μm to 0.001 μm are employed. In some areas, ceramic membranes are also employed.

A frequent structural shape of membrane filtration modules comprises a central discharge pipe surrounded by the membranes via which the filtrate can be conducted out of the membrane filtration module. The membranes are in this case often disposed in a housing or a cartridge shell to which they are connected via a so-called potting. In case of plastic membranes, this is usually an epoxy potting via which the plastic membranes are firmly connected or potted with the housing or the cartridge shell.

The membranes often experience loads due to undesired pressure blows or too quickly changing temperature gradients in cleaning operations. This can result in damages of the membrane or the connection between the potting and the membrane or housing, respectively. In particular when plastic membranes are used, these can tear off or even burst directly at the transition to the potting.

To check the integrity of a membrane filtration module, usually either a pressure holding test or a so-called bubble point test is performed. This is usually done, often also automatically, after cleaning to release the plant again for further production. In the pressure holding test, the completely filled module is evacuated with air under pressure from one side, the pressure being below the pressure leading to the permeation through the membrane. The opposite side is then depressurized and set to be open to the top. After some compensation time, pressure is maintained and the pressure drop is observed during a predetermined period. The pressure drop must not exceed a certain value to pass the test.

It is a disadvantage of this method that it does not indicate what is defective in the membrane filtration module, i.e. a membrane or the potting, and neither the degree of the damage can be derived from it. Moreover, it cannot be determined which membrane is defective at what position.

Therefore, a so-called bubble point test is often carried out which is done manually. For this, the membrane filtration module is removed from the filtration plant and introduced into a separate tub of water. Then pressure is allowed to act upon the membranes and escaping bubbles provide information about the location, type and degree of possible defects.

However, it is a disadvantage of this method that, due to the required removal of the membrane filtration module, it is very cumbersome and can lead to relatively long downtimes of the filtration plant.

### SUMMARY OF THE DISCLOSURE

It is therefore one aspect of the present disclosure to provide a method of checking a membrane filtration module of a filtration plant which in a simplified manner permits to reliably check the integrity of the membrane filtration module.

The disclosure provides a method of checking a membrane filtration module of a filtration plant, wherein the membrane filtration module comprises a discharge pipe for the filtrate and a membrane element for filtering a liquid, including the steps of:

filling the membrane filtration module with a liquid such that the membrane element is completely immersed in the liquid, and

introducing compressed air into the discharge pipe.

By introducing compressed air into the discharge pipe, it is possible to carry out a test method similar to the bubble point method in the installed state of the membrane filtration module. By this, the integrity of the membrane filtration module can be reliably checked in a simplified manner.

So, with the method, the function or integrity of the membrane filtration module, in particular the membrane element, can be checked.

The membrane filtration module can in particular be arranged or installed in a filtration plant. The membrane filtration module can be arranged in the filtration plant in particular in a vertical or an upright position. In other words, the longitudinal axis of the membrane filtration module can extend vertically in the filtration plant.

The membrane element of the membrane filtration module can comprise one or several hollow fiber, plate or wound membranes. As the material for the membranes, plastics, for example polyethersulfone, ceramics or a sintered metal can be used.

The membrane filtration module can in particular comprise a wall which surrounds the membrane element. The wall can in particular be embodied to be cylindrical and can be in particular arranged at the outer surface of a cylindrically embodied membrane element. The one or several membranes of the membrane element can be connected to the wall via a potting, in particular be potted. As a potting, an epoxy resin can be in particular used in the case of a plastic membrane element. The one or several membranes can also be connected to the wall in several regions, for example in the end regions of the membrane element. In other words, the potting can comprise several, in particular separate regions in which the one or several membranes are connected to the wall. By the potting, several membranes, in particular several hollow fiber membranes, can also be connected to each other or potted.

Water can in particular be used as a liquid.

A filtrate or permeate here in particular means the filtered medium. The medium to be filtered can be designated as nonfiltrate. The medium retained by the membranes can be referred to as retentate.

The membrane filtration module can be embodied as dead-end or cross-flow module.

Compressed air here means compressed air which in particular has a pressure of above 1 bar. It can be throttled by a pressure reducer to the value required depending on the type of membrane, in particular such that the introduced compressed air has a pressure between 0.1 bar and 300 bar, in particular between 0.1 bar and 100 bar, in particular between 0.1 bar and 1.5 bar. The pressure can also be smaller than 0.7 bar. The pressure, however, can also be provided without pressure reducer at the required value. So, the compressed air can be air with a pressure between 0.1 bar and 300 bar, in particular between 0.1 bar and 100 bar, in particular between 0.1 bar and 1.5 bar, in particular below 0.7 bar.

The membrane filtration module can remain in the filtration plant for checking it. In other words, the steps of the method of checking the integrity of the membrane filtration module, in particular the membrane element, can be carried out with the membrane filtration module being installed. So, for checking the membrane filtration module, it does not have to be removed from the filtration plant. By this, the checking of the membrane filtration module can be clearly facilitated.

The membrane filtration module can here in particular be arranged in a housing, for example a stainless steel housing, of the filtration plant. In this case, the liquid can be introduced into the housing, so that the membrane element, in particular the complete membrane filtration module, is immersed in the liquid.

The filtration plant can be used for filtering a liquid in the food industry, in particular in the beverage industry. In other words, the filtration plant can be a filtration plant in the food industry, in particular in the beverage industry.

The method can moreover comprise the detection whether one or several air bubbles rise in the liquid. If air bubbles are detected in the liquid, the membrane filtration module can be graded as being defective. If no air bubbles rise in the liquid, the membrane filtration module can be graded as being intact or undamaged.

In particular, one or several hollow fiber membranes can be determined from which at least one air bubble each rises. By this, the exact defective capillary can be identified.

Moreover, the period between the beginning of the introduction of the compressed air and the occurrence of one or several air bubbles in the liquid can be determined. By this, additional information about a possible defect can be obtained in a simple manner.

The method can moreover comprise a determination or at least an assessment of a location of a defect of the membrane element based on the determined period. By this, a position of a possible defect can be determined or at least assessed in a simple manner.

The method can moreover comprise the determination or at least the assessment of a cause and/or degree of a defect based on observed air bubbles if one or several air bubbles are detected in the liquid. For example, based on the location where the air bubble rises, it can be detected in which region of the membrane filtration module a defective membrane is arranged. From the amount of escaping air bubbles, the degree of the defect can be moreover determined or at least assessed. By this, the required sensibility for checking and localizing the defect can be also given.

Compressed air from pneumatic valve controls of the filtration plant for introducing it into the central discharge pipe can be used. By this, a separate compressed air provision device can be omitted.

The pressure of the compressed air of a compressed air provision device can be reduced by means of a pressure reducer. By this, the pressure can be adjusted to a desired value.

The method can moreover comprise the connection of an adapter to the discharge pipe, wherein the compressed air is introduced into the discharge pipe via the adapter.

The adapter can be in particular connected with the discharge pipe from above. In other words, the adapter can be connected with an upper opening of the discharge pipe.

The discharge pipe can extend in particular along the longitudinal axis or the axis of symmetry of the membrane element. In other words, the discharge pipe can be a central discharge pipe, that means it can be in particular arranged concentrically to the axis of symmetry.

The discharge pipe can be designed such that the filtrate can be conducted out of the membrane element into the discharge pipe. For example, the discharge pipe can comprise one or several openings in the region of the first longitudinal section, for example as bores, grooves and/or gaps or annular gaps.

The discharge pipe can have an essentially cylindrical design. So, the discharge pipe can comprise a cylindrical surface area and two opposite ends or mouths.

The discharge pipe can be embodied to be surrounded by the membrane element. In particular, the surface area of the discharge pipe can be surrounded in particular completely by the membrane element.

The disclosure moreover provides an adapter for the connection with a discharge pipe of a membrane filtration module of a filtration plant which is designed such that compressed air can be introduced into the discharge pipe via the adapter.

In other words, the adapter can be used for performing an above-described method. Thereby, the adapter permits a simple and reliable check of a membrane filtration module of a filtration plant.

The adapter can comprise a compressed air supply.

The adapter can in particular comprise a channel extending inside the adapter which connects the compressed air supply with an outer surface of the adapter which is in particular arranged in the discharge pipe of the membrane filtration module when the adapter is connected to the discharge pipe.

In other words, the adapter can, in the state connected with the discharge pipe, be at least partially arranged inside the discharge pipe.

The membrane filtration module can in particular comprise one or several ones of the above-mentioned features.

The adapter can in particular be releasably connected to the discharge pipe, in particular to be releasable without being destructed. For example, the adapter can be connectable to the discharge pipe with a positive or non-positive fit, for example by a pin-and-socket connection.

The adapter can moreover comprise a fixing device for fixing the adapter to a part of the membrane filtration module and/or the filtration plant. By this, it is possible to securely connect the adapter with the central discharge pipe.

The fixing device can in particular be designed such that the position of the adapter relative to the membrane filtration module and/or to the filtration plant can be adjusted with the aid of the fixing device. If the membrane filtration module is arranged in the filtration plant in a vertical orientation, the adapter can be in particular height adjustable via the fixing device.

The fixing device and the adapter can be releasably connected to each other, in particular to be releasable without being destructed, for example via a threaded joint. The fixing device and the adapter, however, can also be unreleasably or firmly connected to each other, in particular not releasable without destruction.

The disclosure moreover provides a system comprising an above-described adapter and a compressed air provision device.

The adapter can in particular comprise one or several ones of the above-mentioned features.

The compressed air provision device can be, for example, a compressor. As an alternative, the compressed air provision device can also correspond to a pneumatic valve control of the filtration plant or comprise such a valve control. By this, a cheaper system can be realized as a separate compressor can be omitted.

The system can moreover comprise a compressed air piping which connects the compressed air provision device and the adapter. Via the compressed air piping, the compressed air can be conducted into the adapter and via the adapter into the discharge pipe.

The system can moreover comprise a pressure reducer. By this, the pressure of the compressed air from the compressed air provision device can be adjusted to a desired value.

### BRIEF DESCRIPTION OF THE DRAWINGS

Further features and advantages of the disclosure will be described below with reference to the exemplary figures. In the drawings:

FIG. 1 shows an illustration of an exemplary membrane filtration module;

FIG. 2 shows an illustration of a part of a filtration plant, comprising an exemplary membrane filtration module;

FIG. 3 shows an illustration of a method of checking a membrane filtration module of a filtration plant; and

FIG. 4 shows an illustration of an exemplary adapter for the connection with a discharge pipe of a membrane filtration module.

### DETAILED DESCRIPTION OF THE PREFERRED EMBODIMENT

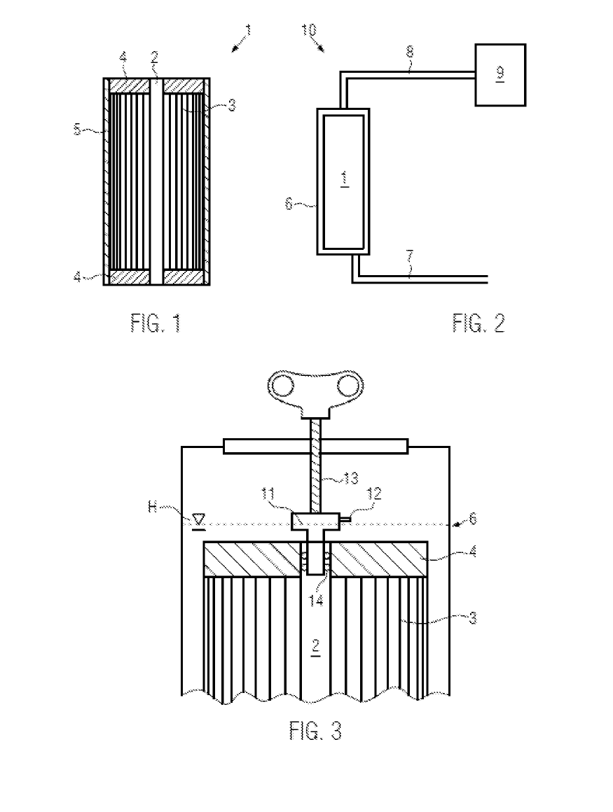

In FIG. 1, an exemplary membrane filtration module 1 with a central discharge pipe 2 is shown. Membrane filtration is employed, for example, in water treatment. These are usually ultrafiltration plants. The membrane filtration module shown in FIG. 1 is a so-called hollow fiber filtration module. In other words, the plastic membranes are embodied in the form of several hollow fibers 3. A membrane filtration module can comprise several hundred to several thousand hollow fiber membranes. For example, 1000 to 5000 hollow fiber membranes can be provided. The (mean) pore size of the membrane can be between 0.8 μm and 0.02 μm.

By a so-called potting 4, the hollow fiber membranes 3 are firmly connected or potted with a cartridge shell 5 at the upper and the lower end.

The exemplary membrane filtration module 1 of FIG. 1 moreover comprises a central discharge pipe 2. Via this discharge pipe 2, the filtrate can be discharged from the membrane filtration module 1.

The discharge pipe is in this example embodied centrally, that means along the axis of symmetry of the membrane filtration module. Principally, however, the discharge pipe can also extend peripherally.

While hollow fiber membranes 3 are represented in this example, the membrane filtration module 1 can also comprise flat membranes or central membranes as membranes.

FIG. 2 shows the exemplary membrane filtration module 1 in a state installed in a filtration plant 10. The membrane filtration module 1 is arranged in a housing 6, for example of stainless steel. Via a supply line 7, nonfiltrate is introduced into a lower region of the membrane filtration module 1. From there, it is introduced into the hollow fiber membranes. The lower end of the central discharge pipe is closed in the process. The medium to be filtered is directed under pressure into the membrane such that the filtrate or permeate is pressed through the pores of the membrane, while substances to be filtered, for example microorganisms, are retained by the membrane. The filtrate then reaches the central discharge pipe via which it can be discharged from the filtration module.

The filtrate can then be conducted via a discharge line 8 into a processing element 9 in which the filtrate is further processed.

In this example, the membrane filtration module 1 is vertically arranged in the filtration plant 10.

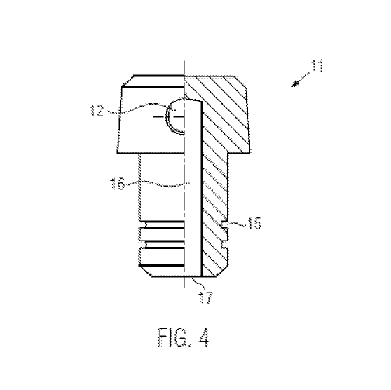

FIG. 3 illustrates an exemplary method of checking the function or integrity of a membrane filtration module of a filtration plant. The membrane filtration module remains in the filtration plant in the process, in particular in the housing 6 of the filtration plant. In the upper region of the housing 6, a cover can be removed, so that the membrane filtration module in the housing 6 becomes accessible from outside. Subsequently, the housing 6 can be drained or filled with a liquid up to the level H (in FIG. 3 represented by the dotted line). By this, the membrane 3 as well as the potting 4 is completely immersed in the liquid, for example water.

In this case, an adapter 11 is connected with the central discharge pipe 2. Sealing rings 14 are provided for sealing the connection. The adapter can in particular be connected with the central discharge pipe 2 before the housing 6 is filled with liquid. The adapter 11 comprises a compressed air supply 12. Via the latter, the adapter 11 can be connected with a compressed air provision device, for example a compressor or the released compressed air piping of a close pneumatic valve control. Via the compressed air provision device, a compressed air piping (neither of them is represented in FIG. 3) and the adapter 11, compressed air is then introduced into the central discharge pipe 2.

If the membranes 3 are intact, the air cannot penetrate into the interior of the hollow membranes 3. Consequently, no bubble formation can be observed in the liquid. If, however, the potting 4 and/or the membrane 3 are defective, compressed air can get inside the membrane 3 or the potting 4, respectively. This leads to the formation of bubbles which can be detected at the surface of the liquid in the container 6. By the localization of the bubbles, the possible location of the defect can be determined, optionally determined very precisely. By observing the time between the occurrence of the bubbles and the application of pressure, the vertical position of the defect can also be determined or at least assessed before far-reaching de-installation measures have to be initiated. Moreover, the manner or the amount of the occurring air bubbles permits an assessment of the degree of the damage. This permits a purposeful decision on the further application of the membrane filtration module and/or on required consequences and/or measures.

Since the membrane filtration module for this checking method does not have to be de-installed from the filtration plant, in particular from the housing 6, the method is easily possible without long downtimes of the filtration plant.

The exemplary adapter 11 in FIG. 3 moreover comprises a fixing device 13 by which the position of the adapter 11 with respect to the housing 6 and/or the membrane filtration module can be determined or fixed. In particular, the fixing device 13 can be designed such that it retains the adapter 11 in position even after compressed air has been introduced.

The exemplary fixing device 13 is moreover designed such that the adapter is height adjustable relative to the membrane filtration module and/or the housing 6. For this, the fixing device 13 comprises a thread and a screw device. The adapter 11 can be fixed by spreading and fixing a cross bracing of the fixing device 13, for example via a sheath clamp for the module lid of the housing 6.

FIG. 4 shows an illustration of an exemplary adapter 11 for the connection with a central discharge pipe 2 of a membrane filtration module of a filtration plant, for example for a method as it is illustrated in FIG. 3. For this, the left half of the illustrated adapter 11 is represented as a side view, and the right half as a cross-section.

The adapter 11 in particular comprises a compressed air supply 12 and a channel 16 connected to it. Via the compressed air supply 12 and the channel 16, compressed air can be directed from the compressed air supply 12 to an outer surface 17 of the adapter which is arranged in the discharge pipe of the membrane filtration module when the adapter is connected to the discharge pipe. In other words, via the channel 16 and the compressed air supply 12, compressed air can be introduced into the discharge pipe.

As an alternative to a separate compressed air supply, the adapter can also comprise only one channel, in particular in the form of a passage opening, in which a compressed air piping can be arranged, in particular wherein the compressed air piping is connected with a compressed air provision device. By this, the adapter can be embodied particularly simply.

At the outer side of the adapter 11, indentations in the form of grooves 15 are moreover embodied. Sealing rings of the discharge pipe can engage in these indentations 15 and thereby permit a tight connection of the adapter 11 with the discharge pipe.

Such an adapter is a relatively small component which can thus be easily transported. By this, an above-described method can be carried out in a simple manner for several spatially separated membrane filtration modules.

It will be understood that features mentioned in the above described embodiments are not restricted to these special combinations and are also possible in any other combinations.

What is claimed is:

1. A method of checking a membrane filtration module of a filtration plant, wherein the membrane filtration module comprises a discharge pipe (2) for the filtrate and a membrane element for the filtration of a liquid, comprising:
filling the membrane filtration module with a liquid, so that the membrane element is completely immersed in the liquid; and
introducing compressed air into the discharge pipe.

2. The method according to claim 1, wherein the filtration module remains in the filtration plant.

3. The method according to claim 1, and determining whether one or several air bubbles rise in the liquid.

4. The method according to claim 3, and determining the period between the start of the introduction of the compressed air and the occurrence of one or several air bubbles in the liquid.

5. The method according to claim 4, and determining or assessing a position of a defect of the membrane element based on the determined period.

6. The method according to claim 3, and determining or assessing one of a cause, a degree or a combination thereof of a defect based on observed air bubbles if one or several air bubbles are detected in the liquid.

7. The method according to claim 1, wherein the compressed air introduced into the discharge pipe is from pneumatic valve controls of the filtration plant.

8. The method according to claim 1, and connecting an adapter with the discharge pipe, wherein the compressed air is introduced into the discharge pipe via the adapter.

9. An adapter for the connection with a discharge pipe of a membrane filtration module of a filtration plant, comprising an adapter device designed such that compressed air can be introduced into the discharge pipe via the adapter device.

10. An adapter according to claim 9, wherein the adapter device comprises a compressed air supply.

11. An adapter according to claim 10, wherein the adapter device comprises a channel extending inside the adapter device which connects the compressed air supply with an outer surface of the adapter device which is arranged in the discharge pipe of the membrane filtration module when the adapter device is connected with the discharge pipe.

12. An adapter according to claim 9, and further comprising a fixing device for fixing the adapter to a part of one of the membrane filtration module, the filtration plant, and a combination thereof.

13. An adapter according to claim 12, wherein the fixing device is designed such that the position of the adapter device can be adjusted relative to one of the membrane filtration module, the filtration plant, and a combination thereof by means of the fixing device.

14. A system for a membrane filtration module of a filtration plant, comprising an adapter according to claim 9 and a compressed air provision device.

15. The system according to claim 9, and further comprising a compressed air piping connecting the compressed air provision device and the adapter.
